(19) United States
(12) Patent Application Publication
(10) Pub. No.: US 2016/0292153 A1
(43) Pub. Date: Oct. 6, 2016

(54) IDENTIFICATION OF EXAMPLES IN DOCUMENTS

(71) Applicant: International Business Machines Corporation, Armonk, NY (US)

(72) Inventors: Lalit Agarwalla, Bangalore (IN); Amit P. Bohra, Pune (IN); Joy Mustafi, Kolkata (IN); Ankur S. Parikh, Bangalore (IN)

(21) Appl. No.: 14/673,934

(22) Filed: Mar. 31, 2015

(51) Int. Cl. G06F 17/30

(52) U.S. Cl. CPC G06F 17/30011; G06F 17/30477

(57) ABSTRACT

In one embodiment of the present invention, one or more sections of a document are identified, and segments of text within the one or more sections are parsed. The parsed segments of text are analyzed to identify parsed segments of text associated with pointers indicative of example content. One or more links are generated between the identified parsed segments of text and one or more topics to which they pertain. Embodiments of the present invention can be used, for example, to increase accuracy of search results by identifying examples in documents returned as search results, as well as by filtering out examples that may cause the main content of text to be obscured in the search results.

### BACKGROUND OF THE INVENTION

The present invention relates generally to the field of information retrieval, and more particularly to text extraction environments.

Information retrieval technology typically comprises a text retrieval tool, such as a search engine, that searches for data on information networks, such as the Internet. Typically, a user connects to a portal or other web site having a search engine where a user can enter a query of a particular topic of interest. A search engine typically “tokenizes” documents by processing documents to understand the document's structure and semantics and creating tokens (i.e., an instance of a sequence of characters in some particular document that are grouped together as a useful semantic unit for processing) to help determine that information contained within documents is relevant to queries. The usefulness of a search engine typically depends on the relevance of the results it returns to the user. Each search engine can be configured differently with different algorithms that help sort and rank results to provide, for example, the most relevant results first.

### SUMMARY

In one embodiment of the present invention, a method is provided comprising: identifying, by one or more computer processors, one or more sections of a document; parsing, by one or more computer processors, segments of text within the one or more sections of the document; analyzing, by one or more computer processors, the parsed segments of text to identify parsed segments of text that are associated with pointers indicative of example content; and generating, by one or more computer processors, one or more links between the identified parsed segments of text and one or more topics to which the identified parsed segments of text pertain.

### BRIEF DESCRIPTION OF THE DRAWINGS

FIG. 1 is a functional block diagram of a computing environment, in accordance with an embodiment of the present invention;

FIG. 2 is a flowchart illustrating operational steps for identifying and linking examples in documents, in accordance with an embodiment of the present invention;

FIG. 3 is a flowchart illustrating operational steps for pre-processing a result, in accordance with an embodiment of the present invention;

FIG. 4 is a flowchart illustrating operational steps for discourse-processing, search-based pointer identification, in accordance with an embodiment of the present invention;

FIG. 5 is a flowchart illustrating operational steps for hyperlink-induced topic search-based pointer identification, in accordance with an embodiment of the present invention;

FIG. 6 is a flowchart illustrating operational steps for brute force identification of candidate example passages, in accordance with an embodiment of the present invention;

FIG. 7 is a flowchart illustrating operational steps for discourse relations-based identification of candidate example passages, in accordance with an embodiment of the present invention;

FIG. 8 is a flowchart illustrating operational steps for extracting examples in documents, in accordance with an embodiment of the present invention;

FIG. 9 is a flowchart illustrating operational steps for validating example passages, in accordance with an embodiment of the present invention; and

FIG. 10 is a flowchart illustrating operational steps for performing a search, in accordance with an embodiment of the present invention.

FIG. 11 is a block diagram of internal and external components of the computer systems of FIG. 1, in accordance with an embodiment of the present invention.

### DETAILED DESCRIPTION

Embodiments of the present invention recognize the problem that, a search engine may mistakenly prioritize a result because of the tokens present in the illustrations and examples of a document. Embodiments of the present invention provide solutions for identifying and extracting illustrations and examples so that the main content of the text is not obscured in the search results. In this manner, as discussed in greater detail later in this specification, embodiments of the present invention can be used to provide more accurate search results by filtering out tokens identified in the illustrations and examples of a document to increase the accuracy of search results.

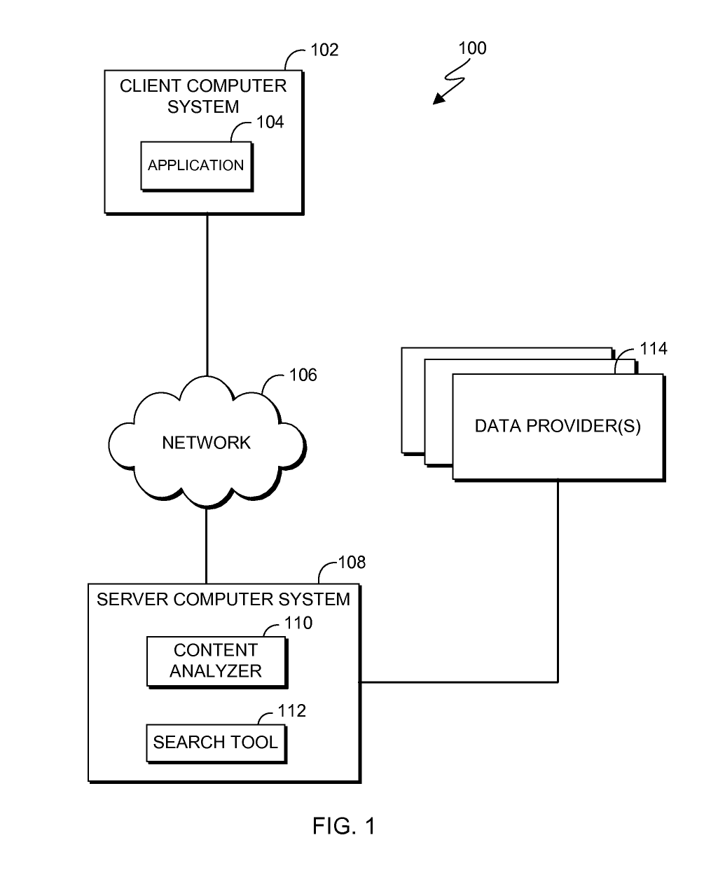

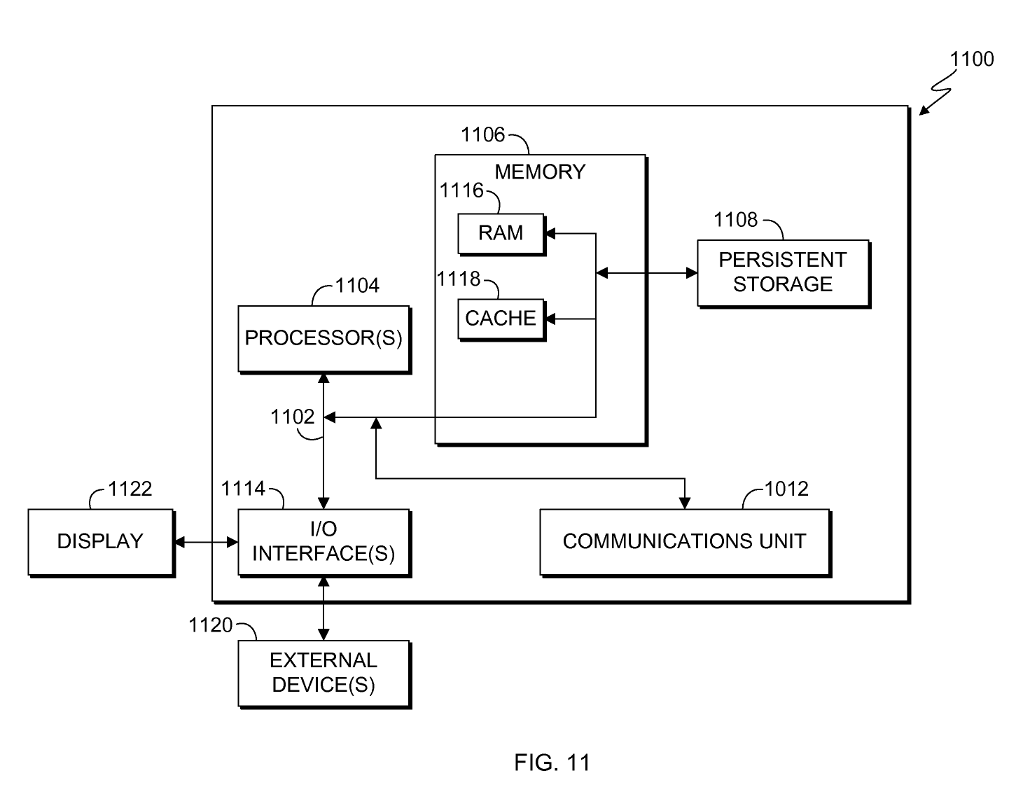

FIG. 1 is a functional block diagram of a computing environment 100, in accordance with an embodiment of the present invention. Computing environment 100 includes client computer system 102, server computer system 108, and data providers 114 interconnected by network 106. Client computer system 102 and server computer system 108 can be desktop computers, laptop computers, specialized computer servers, or any other computer systems known in the art. In certain embodiments, client computer system 102 and server computer system 108 represent computer systems utilizing clustered computers and components to act as a single pool of seamless resources when accessed through network 106. In certain embodiments, client computer system 102 and server computer system 108 represent virtual machines. In general, client computer system 102 and server computer system 108 are representative of any electronic devices, or combination of electronic devices, capable of executing machine-readable program instructions, as described in greater detail with regard to FIG. 11.

Client computer system 102 includes application 104. Application 104 enables client computer system 102 to access search tool 112. Application 104 communicates with server computer system 108 via network 106 (e.g., using TCP/IP) to enter one or more search queries. A search query is a string of query terms pertaining to a particular subject area that is of interest to a user. For example, application 104 can be implemented using a browser and web portal or any program that transmits search queries to, and receives results from, server computer system 108.

Network 106 can be, for example, a local area network (LAN), a wide area network (WAN) such as the Internet, or a combination of the two, and include wired, wireless, or fiber optic connections. In general, network 106 can be any combination of connections and protocols that will support communications between client computer system 102, server computer system 108, and data providers 114, in accordance with a desired embodiment of the invention.

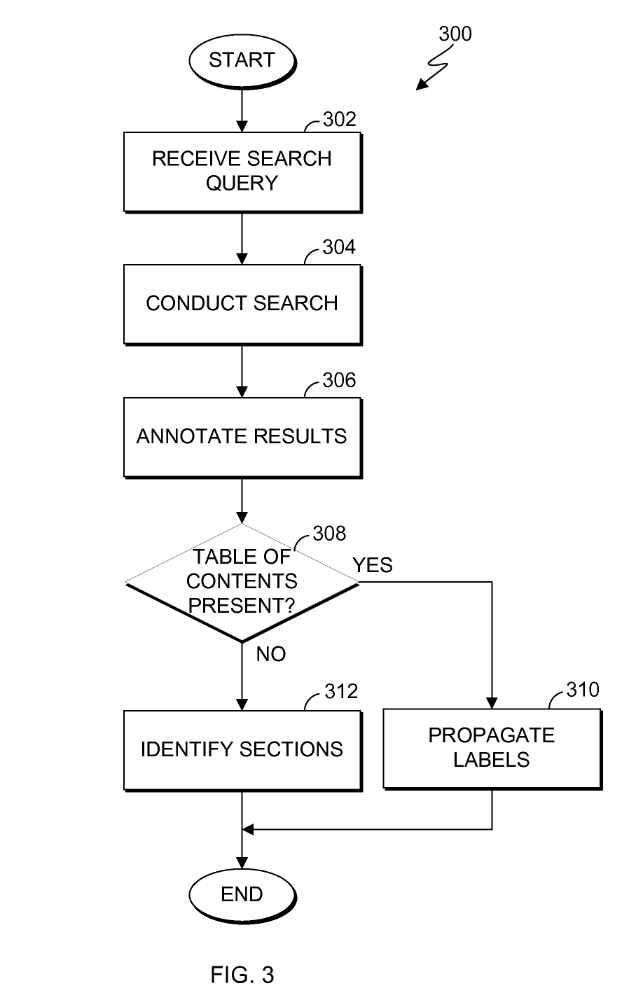

Server computer system 108 includes content analyzer 110 and search tool 112. Content analyzer 110 can receive content from one or more components of computing environment 100 and identify a list of example passages, and annotate the identified example passages on the received content. For example, content analyzer 110 can receive content from data providers 114, process the content, and identify and annotate examples for content that content analyzer 110 received, as discussed in greater detail with regard to FIGS. 3-7.

Search tool 112 is capable of executing a search query and returning results to application 104 via network 106. For example, search tool 112 can search content that content analyzer 110 previously annotated, and retrieve example passages that match one or more terms of the search query.

In another embodiment of the present invention, search tool 112 is capable of executing a search query using content analyzer 110 during a search to exclude example passages from its search results. For example, content analyzer 110 can process retrieved results, and identify and annotate examples during an execution of a search query. Search tool 112 can then exclude tokens found on those example passages from its scoring and ranking scheme to return more accurate search results to application 104 via network 106.

Data providers 114 represent one or more content sources that can be searched by search tool 112. For example, data providers 114 can be web pages, databases, etc. Content on data providers 114 can include structured and unstructured content, such as documents containing text, hyperlinks, and other information. Content stored on data providers 114 can be stored on a tape library, optical library, one or more independent hard disk drives, or multiple hard disk drives in a redundant array of independent disks (RAID). In general, content on data providers 114 can be stored on any storage media known in the art. Similarly, content on data providers 114 can be implemented with any suitable storage architecture known in the art, such as a relational database, an object-orientated database, and/or one or more tables.

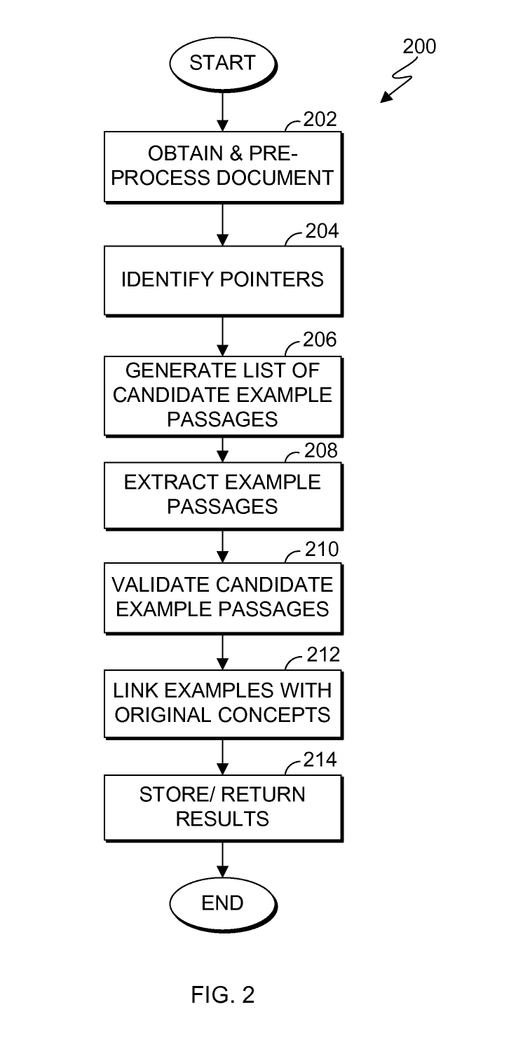

FIG. 2 is a flowchart 200 illustrating operational steps for identifying and linking text and illustrations in a text document, in accordance with an embodiment of the present invention.

In step 202, content analyzer 110 obtains a document from one or more components of computing environment 100 and pre-processes the document. In this embodiment, content analyzer 110 parses the document by using natural language annotations and section metadata extraction, as discussed in greater detail with regard to FIG. 3. In other embodiments, content analyzer 110 can receive search results (e.g., a document), from search tool 112.

In step 204, content analyzer 110 analyzes the document and identifies “pointers”. The term “pointers”, as used herein, refers to segments of text that are used to identify example passages. In this embodiment, content analyzer 110 can use keywords to identify pointers. For example, content analyzer 110 can identify a sentence as a pointer if it contains at least one of the desired keywords. Desired keywords could be example-related discourse connectives such as “for instance” and “for example”, example-related nouns such as “example”, “illustration”, “case study” , example-related verbs such as “illustrated”, or domain specific terms such as “medical case”. Desired keywords can also be based, at least in part, on the search query entered on search tool 112 and can be configured based on business context.

In other embodiments, content analyzer 110 can use sentence-level discourse parsing to extract the rhetorical structure of the document, and/or hyperlink-induced topic search methods to identify pointers. In general, content analyzer 110 can use any of the above described methods to identify pointers singularly, or in combination, based on the type of document (e.g., web page, text book, manual, etc.) and the domain of the document (e.g., healthcare, finance, telecommunication, etc.). The selection of methods can be configured in any desired manner.

In step 206, content analyzer 110 generates a list of candidate example passages using pointers identified in step 204. The phrase “candidate example passages”, as used herein, refers to text within a document that provides support for, elaboration of, or examples of one or more topics presented in retrieved results (e.g., documents). In this embodiment, content analyzer 110 uses a heuristics-based method to generate possible candidate example passages, such as a “Two Pointers” method. The phrase “Two Pointers Method”, as used herein, refers to a process of identifying candidate example passages based on two previously identified pointers. For example, in a five sentence paragraph, the first and last sentence can contain two pointers. Content analyzer 110 can then identify those two pointers and selects sentences two through four as a candidate example passage.

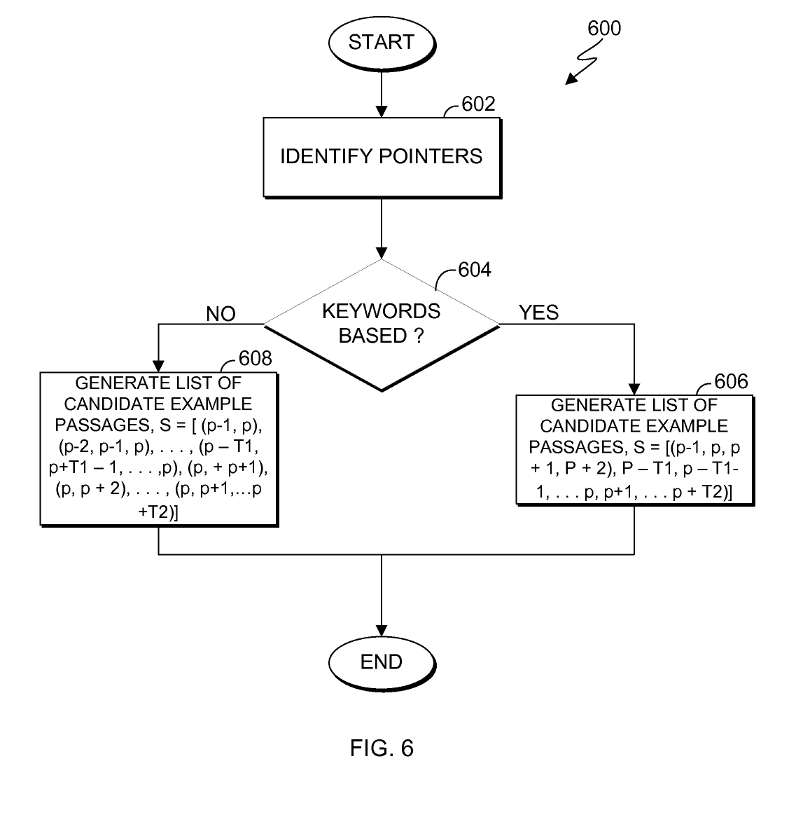

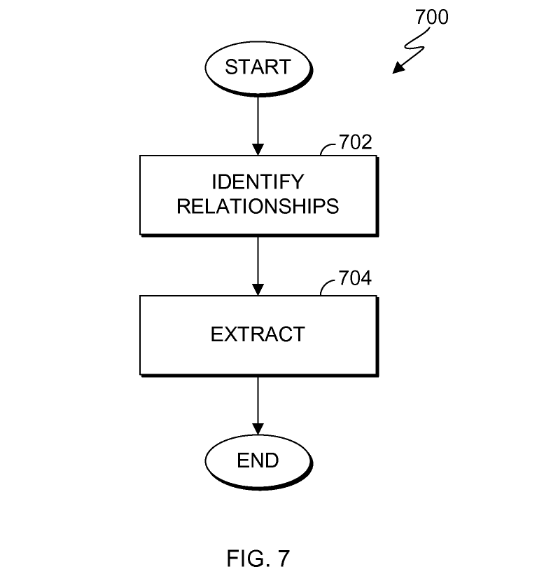

In other embodiments, content analyzer 110 can use a brute force method or a discourse relations-based method to generate possible candidate example passages singularly, or in combination, based on the type of document (e.g., a web page, a textbook, a manual, etc.) and the domain of the document (e.g., healthcare, finance, telecommunication etc.), as discussed in greater detail with regard to FIGS. 6 and 7, respectively.

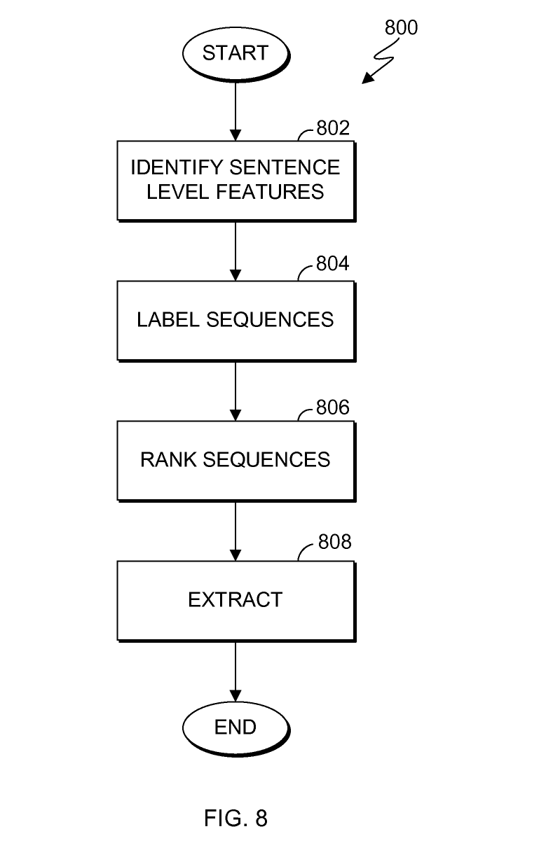

In step 208, content analyzer 110 extracts example passages. In this embodiment, content analyzer 110 extracts example passages by identifying sentence-level features from each of the sentences of possible candidate example passages and passes them to a pre-trained machine learning model to extract example candidate passages, as discussed in greater detail with regard to FIG. 8.

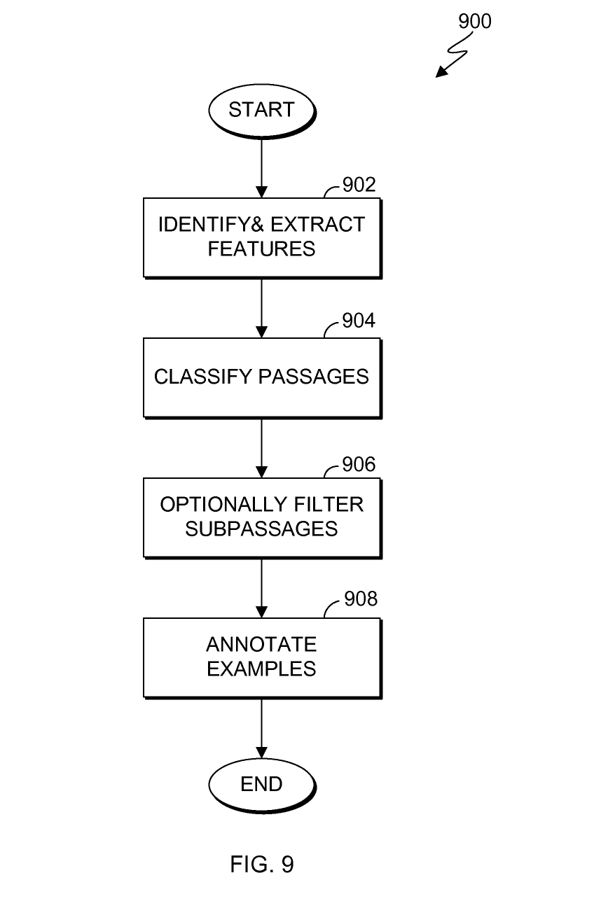

In step 210, content analyzer 110 validates candidate example passages using various passage level features and pre-trained machine learning model, as discussed in greater detail with regard to FIG. 9.

In step 212, content analyzer 110 links examples with original concepts by extracting frequent keywords and annotating the example passages. The term “original concepts”, refers to segments of text that express the topic of a paragraph. In this embodiment, content analyzer 110 extracts keywords from the example passages, neighbor passages, section title, document title, sentences having example related keywords, and sentences before and after example related key words.

Content analyzer 110 can then identify a subset of keywords as original concepts that exceed a pre-defined frequency threshold. The threshold can be set by corpus analysis or by previously obtained example passages. If, for example, the frequency threshold is set to five, keywords that appear five or more times are identified as original concepts.

In step 214, content analyzer 110 stores the identified and linked example passages. If, for example, search tool 112 conducted a search for example passages, then content analyzer 110 can return identified example passages that match one or more terms of the search query. For example, search tool 112 can conduct a search for “an example of service level agreements”. Content analyzer 110 can then search the identified example passages, and transmits those identified example passages that match “service level agreements”. In other embodiments, content analyzer 110 can call search tool 112 to filter out tokens in the identified example passages from its ranking and scoring scheme before returning the search results to the user.

Accordingly, in this embodiment, examples in documents that could be laden with tokens that would obfuscate the main content of the document are identified. Those examples can then be filtered out of the ranking and scoring scheme of a search tool, thereby providing more accurate search results.

FIG. 3 is a flowchart 300 illustrating operational steps for pre-processing a result, in accordance with an embodiment of the present invention. For example, the operational steps of flowchart 300 can be performed in step 202 of flowchart 200.

In step 302, search tool 112 receives a search query from application 104. In other embodiments, search tool 112 can receive a search query from one or more other components of computing environment 100.

In step 304, search tool 112 conducts a search. In this embodiment, search tool 112 conducts a search according to the search query and obtains one or more results. For example, search tool 112 may receive a search query for “service level agreements”. Search tool 112 can then conduct a search on data providers 114 for content that matches the search query, and retrieve one or more results that correspond to one or more terms of the search query (e.g., a document).

In step 306, search tool 112 calls content analyzer 110 to annotate the results. In this embodiment, content analyzer 110 uses natural language annotations (e.g., sentence splitting, tokenization, POS tagging, chunking, dependency parsing, and anaphora resolution, etc.) to process the semantics of the results (e.g., a document). For example, content analyzer 110 can use sentence splitting to identify segments of text according to punctuation (e.g., a comma, a period, an exclamation point, a question mark, etc.) in a document containing text.

In step 308, search tool 112 calls content analyzer 110 to determine whether a table of contents is present in the result. In this embodiment, content analyzer 110 uses section metadata extraction to identify the presence or absence of a “Table of Contents” and classify each section of text as a chapter, section, and subsections. For example, content analyzer 110 can identify a “table of contents” by using various keyword-based, number-based, and textual similarity-based features.

If, in step 308, content analyzer 110 determines that a table of contents is present, then, in step 310, content analyzer 110 propagates the label assigned to the table of content entries to the appropriate content in the document by conducting a textual similarity-based search. For example, content analyzer 110 could identify that page 1 of a document is a table of content page. Content analyzer 110 can then process that page, and classifies each line or entry of the table of content pages into sections such as chapter, section, sub-section, etc. using various text style- and indentation-based features. Content analyzer 110 can then propagate the label assigned to the table of content entries to the appropriate content in the document by applying textual similarity-based search. For example, content analyzer 110 could identify from the table of contents, that the document has 3 sections (e.g., Section 1, Section 2, and Section 3, respectively), and that Section 1 had two subsections (e.g., a and b). Content analyzer 110 then conducts a textual similarity-based search and then identifies “Section 1” from the table of contents with the “Section 1” containing content, later in the document.

If, in step 308, content analyzer 110 determines that a table of contents is not present, then, in step 312, content analyzer 110 identifies different sections. In this embodiment, content analyzer 110 performs heuristic-based sentence splitting by searching for delimiters, such as punctuation (e.g., a comma, a period, an exclamation point, a question mark, etc.), to identify a sentence boundary. Content analyzer 110 can also use style transition-based splitting to split sentences into respective sections. For example, content analyzer 110 can identify style transitions, such as a bigger font size, to denote different sections of a document.

Accordingly, in this embodiment, a search result is obtained and processed to understand the semantics and structure of the search result. The semantics and structure of the search result can then be used to identify example passages that could be laden with tokens, which can then be filtered out of a search tool's scoring and ranking scheme, thereby improving search results.

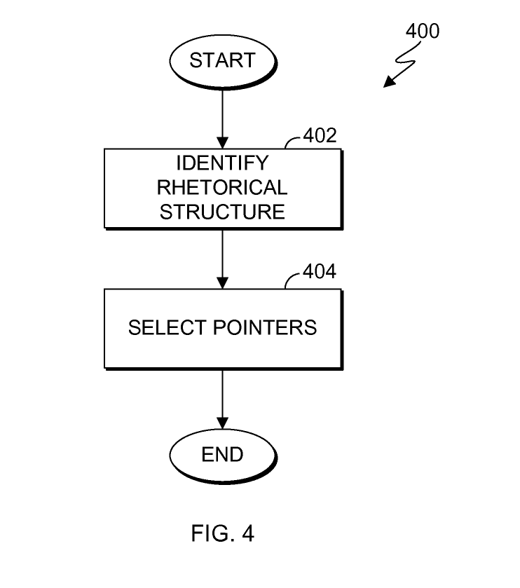

FIG. 4 is a flowchart 400 illustrating operational steps for discourse-processing, search-based pointer identification, in accordance with an embodiment of the present invention. For example, the operational steps of flowchart 400 can be performed in step 204 of flowchart 200.

In step 402, content analyzer 110 identifies the rhetorical structure of a search result (e.g., a document). In this embodiment, content analyzer 110 uses sentence-level discourse parsing to identify sentences and assign a relationship between the two sentences. For example, the relationship between two sentences can be circumstance, solution hood, elaboration, background, enablement, motivation, evidence, justify, cause, antithesis, concession, condition, interpretation evaluation, restatement, summary, sequence, contrast, etc.

In step 404, content analyzer 110 selects pointers. In this embodiment, content analyzer 110 selects sentences as pointers if their neighbor sentences (i.e., the sentence, immediately before and after) have desired relationships such as elaboration, background, etc. For example, in a paragraph of 12 sentences, sentences 6-9, for which the previous 5 sentences have a background relationship and the next 3 sentences (10-12) have elaboration relationships, would be identified as pointers.

Accordingly, in this embodiment, pointers are identified which can be leveraged to identify example passages that may obscure the original content's topic. These example passages can then be filtered out of a search tool's scoring and ranking scheme, thereby improving search results returned to a user.

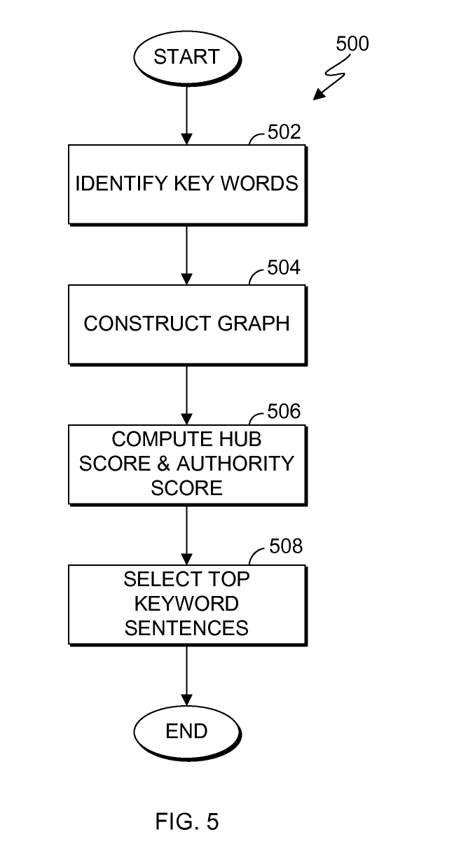

FIG. 5 is a flowchart 500 illustrating operational steps for Hyperlink-Induced Topic Search (HITS) based pointer identification, in accordance with an embodiment of the present invention. For example, the operational steps of flowchart 400 can also be performed in step 204 of flowchart 200.

In step 502, content analyzer 110 identifies keywords as previously discussed with regard to step 202 of flowchart 200.

In step 504, content analyzer 110 constructs a graph of the keywords. In this embodiment, content analyzer 110 constructs a graphs where all the sentences and keywords are nodes. For example, a search query could have three keywords, one through three, and can be “service”, “company”, and “entity”, respectively, and the result returned could be a five sentence document. Content analyzer 110 can then construct a graph of all the sentences (e.g., sentences one through five), detect which keywords are found in each sentence, and plot points on the graph that correspond to the presence of each keyword in each respective sentence. For example, content analyzer 110 can detect that sentence one has keywords one and two, sentence two has keywords one, two, and three, and so on.

In step 506, content analyzer 110 computes a hub score and authority score. The phrase “hub score”, as used herein, refers to the summation of all the keywords found in a sentence. The phrase “authority score”, as used herein, refers to the summation of all the sentences designated as pointers that “point” to the identified sentence. Both are recursive in nature.

In step 508, content analyzer 110 selects top keyword sentences according to the Hub and Authority Score.

Accordingly, in this embodiment, pointers are identified which can be leveraged to identify example passages that may obscure the topic of the original content. These example passages can then be filtered out of a search tool's scoring and ranking scheme, thereby improving search results returned to a user.

FIG. 6 is a flowchart 600 illustrating operational steps for brute force identification of candidate example passages, in accordance with an embodiment of the present invention. For example, the operational steps of FIG. 6 can be performed at step 206 of flowchart 200.

In step 602, content analyzer 110 identifies pointers using keywords, sentence-level discourse parsing, and/or hyperlink-induced topic search methods, as previously discussed with regard to step 202, steps 402-404, and steps 502-508 of flowcharts 200, 400, and 500, respectively. Again, content analyzer 110 can use any of the above described methods to identify pointers in combination, or singularly, based on the type of document (e.g., web page, text book, manual, etc.) and the domain of the document (e.g., healthcare, finance, telecommunication, etc.).

In step 604, content analyzer 110 determines whether the pointers were identified using keywords. In this embodiment, content analyzer 110 obtains the pointers and reads how each pointer was identified.

If, in step 604, content analyzer 110 determines that the pointer was identified using keywords, then in step 606, content analyzer 110 uses a brute force method to generate candidate example passages. In this embodiment, content analyzer 110 uses the following formula to generate candidate example passage:

S=[(p−1, p, p+1, P+2), P−T1, p−T1−1, . . . p, p+1, . . . p+T2)] Formula 1

where P represents pointer sentences, p+1 represent sentence after point sentence, p−1 represents the sentence before the pointer system, and T1 and T2 represent how many sentences before and after the pointer will be examined, respectively. In general T1 and T2 can be configured to any specified number before or after the pointer sentence (e.g., one, two, three, four, five, etc.).

If, in step 604, content analyzer 110 determines that the pointer was not identified using keywords, then in step 608, content analyzer 110 uses the following formula to generate candidate example passage:

S=[(p−1, p), (p−2, p−1, p), . . . , (p−T1, p+T1−1, . . . , p), (p, +p+1), (p, p+2), . . . , (p, p+1, . . . p+T2)] Formula 2

where p=represents the pointer sentence, p+1 represents the sentence after the pointer sentence, p−1 represents the sentence before the pointer sentence and T1 and T2 represents how many sentences before and after the pointer will be examined, respectively. In general, T1 and T2 can be configured to any specified number before or after the pointer sentence (e.g., one, two, three, four, five, etc.).

Accordingly, in this embodiment, candidate example passages are identified. These example passages can then be filtered out of a search tool's scoring and ranking scheme, thereby improving search results returned to a user.

FIG. 7 is a flowchart 700 illustrating operational steps for discourse relations-based identification of candidate example passages, in accordance with an embodiment of the present invention. For example, the operational steps of FIG. 7 can be also performed at step 206 of flowchart 200.

In step 702, content analyzer 110 identifies the desired relationships between sentences. For example, content analyzer 110 can detect all sentences having desired relationships. Again, desired relationships between two sentences can be circumstance, solution hood, elaboration, background, enablement, motivation, evidence, justify, cause, antithesis, concession, condition, interpretation evaluation, restatement, summary, sequence, and contrast, etc.

In step 704, content analyzer 110 uses iterative sentence extraction to extract all sentences having some relationship with previously identified pointers.

Accordingly, in this embodiment, candidate example passages are identified. These example passages can then be filtered out of a search tool's scoring and ranking scheme, thereby improving search results returned to a user.

FIG. 8 is a flowchart 800 illustrating operational steps for extracting examples in documents, in accordance with an embodiment of the present invention. For example, the operational steps of FIG. 8 can be performed at step 208 of flowchart 200.

In step 802, content analyzer 110 identifies sentence-level features. In this embodiment, content analyzer 110 uses sentence-level features to classify the candidate example passages. For example, the sentence-level features used to classify the candidate example passages are contextual features, such as the subject of the sentence, object of the sentence, presence of named entities that are not identified as key phrases, hub score of the sentence (if available), similarity of subject or object of the current sentence with subject and object of the previous sentence, presence of example related keywords, discourse relations (if available), etc.

For context, content analyzer 110 can examine the two previous sentences, and the next two sentences as well, for sentence-level features. Content analyzer 110 then uses the identified sentence-level features to generate a sequence of elements for each of these passages where each element is a set of features.

In step 804, content analyzer 110 uses a sequence labeling algorithm, such as Conditional Random Field, for classification of each element of sequence into B, I, and O classes. B represents the beginning of the sentence of a candidate example. I represents the intermediate sentences of a candidate example. O represents other sentences than the candidate examples. Content analyzer 110 then extracts sentences labeled B and I.

In step 806, content analyzer 110 ranks each extracted sentence. In this embodiment, content analyzer 110 ranks each extracted sentence by calculating the conditional probability of the continuous sequences identified in the previous step using Conditional Random Field (i.e., a statistical modelling method). The extracted sentences are ranked according to the score. The highest score receives the best ranking. For example, the highest score receives the number one ranking. Content analyzer 110 selects the best ranking sentences as candidate examples.

In step 808, content analyzer 110 extracts the candidate example passage.

Accordingly, in this embodiment, candidate example passages are extracted. These example passages can then be filtered out of a search tool's scoring and ranking scheme, thereby improving search results returned to a user.

FIG. 9 is a flowchart 900 illustrating operational steps for validating example passages, in accordance with an embodiment of the present invention. For example, the operational steps of FIG. 9 can be performed at step 210 of flowchart 200.

In step 902, content analyzer 110 identifies and extracts passage level features. In this embodiment, content analyzer 110 extracts various passage level features from all passages by searching for the presence of example related keywords, deviation or histogram of cumulative hub-score, deviation or histogram of cumulative authority score, deviation or histogram of percentage of named entities that are not keywords, deviation or histogram of percentage of sentences having pronouns as subjects, deviation or histogram of percentage of sentences having key words as main objects, etc.

In step 904, content analyzer 110 classifies passages. In this embodiment, content analyzer 110 classifies the extracted passages by applying a binary object labeling machine learning algorithm (e.g., Support Vector Machine) using previously extracted features.

In step 906, content analyzer 110 optionally filters sub passages. In this embodiment, content analyzer 110 filters passages that are classified as an example and are part of other longer passages that are also classified as an example, and creates an annotation to all remaining passages that are classified as an example.

In step 908, content analyzer 110 annotates example passages. In this embodiment, content analyzer 110 annotates the identified example passages by marking them as examples and linking them to the original content.

Accordingly, example passages are linked to the original content of the document so that in question and answer schemes, a search tool can direct a user to examples within the original content.

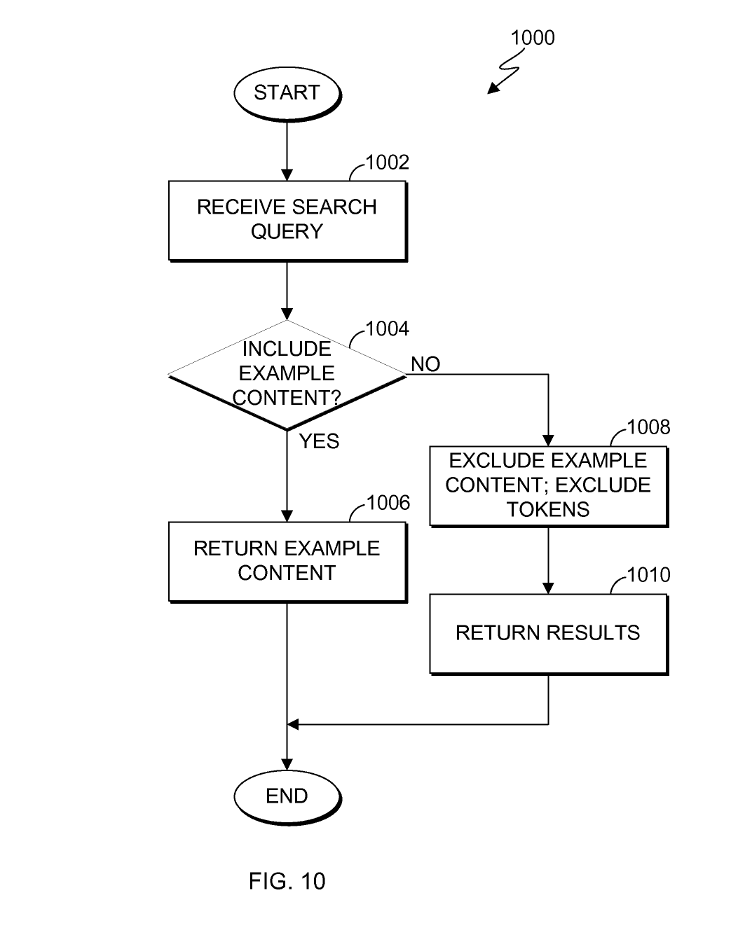

FIG. 10 is a flowchart 1000 illustrating operational steps for performing a search, in accordance with an embodiment of the present invention.

In step 1002, search tool 112 receives a search query from application 104. The search query can further specify whether results should include or exclude example content. For example, a user can specify to include example content of a topic of the search query. Conversely, a user can specify to exclude example content of the topic. In other embodiments, search tool 112 can receive a search query from one or more other components of computing environment 100.

In step 1004, search tool 112 determines whether example content should or should not be included in a search result. In this embodiment, search tool 112 determines example content should or should not be included in a search result based, at least in part, on the received search query, which contains data indicating whether results should include or exclude example content.

If, in step 1004, search tool 112 determines that example content should be included in a search result, then, in step 1006, search tool 112 returns example content that matches one or more terms of the search query to application 104. In this embodiment, search tool 112 accesses annotated example content (i.e., previously identified parsed segments of text) generated by content analyzer 110 and returns as a result example content of a topic found in an annotated document that matches one or more terms of the search query. For example, search tool 112 can receive a search query specifying that example content for a topic pertaining to computers should be returned. Search tool 112 can then access previously annotated documents containing linked example content pertaining to computers. Search tool 112 can then return as a result all documents containing the linked example content pertaining to computers.

Optionally, search tool 112 can filter a document containing example content to return as a result only the segments of the document containing example content. For example, search tool 112 can receive a search query specifying that only example content should be displayed for a topic pertaining to computers. Search tool 112 can then access the linked example content pertaining to computers and identify that paragraphs two through four of a five paragraph document include the desired example content. Search tool 112 then filters out paragraphs one and five and return as a result paragraphs two through four.

If, in step 1004, search tool 112 determines that example content should not be included in a search result, then, in step 1008, search tool 112 excludes example content. In this embodiment, search tool 112 accesses annotated example content (i.e., previously identified parsed segments of text) generated by content analyzer 110 and returns as a result one or more sections of an annotated document that exclude example content that matches one or more terms of the search query. For example, search tool 112 can receive a search query specifying that example content for a topic pertaining to computers should not be returned. Search tool 112 can then access previously annotated documents containing linked example content pertaining to computers. Search tool 112 can then return as a result sections of documents that do not contain the linked example content pertaining to computers. For example, search tool 112 can access the linked example content pertaining to computers and identify that paragraphs two through four of a five paragraph document include the example content to be excluded. Search tool 112 can then filter out paragraphs two through four and return as a result paragraphs one and five.

Optionally, search tool 112 can exclude tokens found in the example content. In this embodiment, search tool 112 can receive a search query that indicates that it should exclude tokens found in the example content. The term “tokens”, as used herein, refers to an instance of a sequence of characters in some particular document that are grouped together as a useful semantic unit for processing. For example, search tool 112 can receive a search query pertaining to computers. The received search query can further specify that tokens such as “computers” found in example content pertaining to computers should be excluded from the scoring and ranking scheme of search tool 112. Search tool 112 can then access the linked example content pertaining to computers and identify that paragraphs two through four of a five paragraph document include example content containing tokens. Search tool 112 can then exclude tokens found in paragraphs two through four and only use tokens found in paragraphs one and five in its scoring and ranking scheme.

In step 1010, search tool 112 returns the results to application 104.

Accordingly, in this embodiment, a search is performed and the quality of the search results returned to a user can be improved by selectively included or excluded identified example content from search results based on, for example, user preference.

FIG. 11 is a block diagram of internal and external components of a computer system 1100, which is representative the computer systems of FIG. 1, in accordance with an embodiment of the present invention. It should be appreciated that FIG. 11 provides only an illustration of one implementation and does not imply any limitations with regard to the environments in which different embodiments may be implemented. In general, the components illustrated in FIG. 11 are representative of any electronic device capable of executing machine-readable program instructions. Examples of computer systems, environments, and/or configurations that may be represented by the components illustrated in FIG. 11 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 1100 includes communications fabric 1102, which provides for communications between one or more processors 1104, memory 1106, persistent storage 1108, communications unit 1112, and one or more input/output (I/O) interfaces 1114. Communications fabric 1102 can be implemented with any architecture designed for passing data and/or control information between processors (such as microprocessors, communications and network processors, etc.), system memory, peripheral devices, and any other hardware components within a system. For example, communications fabric 1102 can be implemented with one or more buses.

Memory 1106 and persistent storage 1108 are computer-readable storage media. In this embodiment, memory 1106 includes random access memory (RAM) 1116 and cache memory 1118. In general, memory 1106 can include any suitable volatile or non-volatile computer-readable storage media. Software is stored in persistent storage 1108 for execution and/or access by one or more of the respective processors 1104 via one or more memories of memory 1106.

Persistent storage 1108 may include, for example, a plurality of magnetic hard disk drives. Alternatively, or in addition to magnetic hard disk drives, persistent storage 1108 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 1108 can also be removable. For example, a removable hard drive can be used for persistent storage 1108. Other examples include optical and magnetic disks, thumb drives, and smart cards that are inserted into a drive for transfer onto another computer-readable storage medium that is also part of persistent storage 1108.

Communications unit 1112 provides for communications with other computer systems or devices via a network (e.g., network 106). In this exemplary embodiment, communications unit 1112 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to client computer system 102 through communications unit 1112 (e.g., via the Internet, a local area network or other wide area network). From communications unit 1112, the software and data can be loaded onto persistent storage 1108.

One or more I/O interfaces 1114 allow for input and output of data with other devices that may be connected to computer system 1100. For example, I/O interface 1114 can provide a connection to one or more external devices 1120 such as a keyboard, computer mouse, touch screen, virtual keyboard, touch pad, pointing device, or other human interface devices. External devices 1120 can also include portable computer-readable storage media such as, for example, thumb drives, portable optical or magnetic disks, and memory cards. I/O interface 1114 also connects to display 1122.

Display 1122 provides a mechanism to display data to a user and can be, for example, a computer monitor. Display 1122 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
identifying, by one or more computer processors, one or more sections of a document;
parsing, by one or more computer processors, segments of text within the one or more sections of the document;
analyzing, by one or more computer processors, the parsed segments of text to identify parsed segments of text that are associated with pointers indicative of example content; and
generating, by one or more computer processors, one or more links between the identified parsed segments of text and one or more topics to which the identified parsed segments of text pertain.

2. The method of claim 1, further comprising:
responsive to receiving a query, returning as a result, by one or more computer processors, one or more of the parsed segments of text based, at least in part, on the generated one or more links.

3. The method of claim 2, wherein responsive to receiving a query, returning as a result, by one or more computer processors, one or more of the parsed segments of text based, at least in part, on the generated one or more links comprises:
responsive to receiving a query for example content, returning as a result, by one or more computer processors, the identified parsed segments of text.

4. The method of claim 3, further comprising:
excluding, by one or more computer processors, tokens found in the identified parsed segments of text from a scoring and ranking scheme used to process the query.

5. The method of claim 2, wherein responsive to receiving a query, returning as a result, by one or more computer processors, one or more of the parsed segments of text based, at least in part, on the generated one or more links comprises:
responsive to receiving a query that indicates example content should be excluded from a search result, returning as a result, by one or more computer processors, one or more of the parsed segments of text, excluding the identified parsed segments of text.

6. The method of claim 1, wherein analyzing, by one or more computer processors, the parsed segments of text to identify parsed segments of text that are associated with pointers indicative of example content comprises:
identifying, by one or more computer processors, keywords in one or more sections of the document that match a term of a query; and
selecting, by one or more computer processors, sentences of the document containing the identified keywords.

7. The method of claim 1, further comprising:
constructing, by one or more computer processors, a graph of keywords and sentences within the document;
computing, by one or more computer processors, a hub score and an authority score for each sentence using the constructed graph; and
generating, by one or more computer processors, a list of identified parsed segments of text based, at least in part, on the hub score and the authority score of each sentence.

8. The method of claim 1, wherein analyzing, by one or more computer processors, the parsed segments of text to identify parsed segments of text that are associated with pointers indicative of example content comprises:
identifying, by one or more computer processors, a first parsed segment of text containing a first pointer indicative of example content;
identifying, by one or more computer processors, a second parsed segment of text containing a second pointer indicative of example content; and
identifying, by one or more computer processors, a third parsed segment of text between the first and second parsed segments of text, wherein the third parsed segment of text does not contain a pointer indicative of example content.

9. A computer program product comprising:
one or more computer-readable storage media and program instructions stored on the one or more computer-readable storage media, the program instructions comprising:
program instructions to identify one or more sections of a document;
program instructions to parse segments of text within the one or more sections of the document;
program instructions to analyze the parsed segments of text to identify parsed segments of text that are associated with pointers indicative of example content; and
program instructions to generate one or more links between the identified parsed segments of text and one or more topics to which the identified parsed segments of text pertain.

10. The computer program product of claim 9, wherein the program instructions stored on the one or more computer-readable storage media further comprise:
program instructions to, responsive to receiving a query, return as a result one or more of the parsed segments of text based, at least in part, on the generated one or more links.

11. The computer program product of claim 10, wherein the program instructions to, responsive to receiving a query, return as a result one or more of the parsed segments of text based, at least in part, on the generated one or more links comprise:
program instructions to, responsive to receiving a query for example content, return as a result the identified parsed segments of text.

12. The computer program product of claim 11, wherein the program instructions stored on the one or more computer-readable storage media further comprise:
program instructions to exclude tokens found in the identified parsed segments of text from a scoring and ranking scheme used to process the query.

13. The computer program product of claim 10, wherein the program instructions to, responsive to receiving a query, return as a result one or more of the parsed segments of text based, at least in part, on the generated one or more links comprise:
program instructions to, responsive to receiving a query that indicates example content should be excluded from a search result, return as a result one or more of the parsed segments of text, excluding the identified parsed segments of text.

14. The computer program product of claim 9, wherein the program instructions to analyze the parsed segments of text to identify parsed segments of text that are associated with pointers indicative of example content comprise:
program instructions to identify keywords in one or more sections of the document that match a term of a query; and
program instructions to select sentences of the document containing the identified keywords.

15. The computer program product of claim 9, wherein the program instructions stored on the one or more computer-readable storage media further comprise:
program instructions to construct a graph of keywords and sentences within the document;
program instructions to compute a hub score and an authority score for each sentence using the constructed graph; and
program instructions to generate a list of identified parsed segments of text based, at least in part, on the hub score and the authority score of each sentence.

16. The computer program product of claim 9, wherein the program instructions to analyze the parsed segments of text to identify parsed segments of text that are associated with pointers indicative of example content comprise:
program instructions to identify a first parsed segment of text containing a first pointer indicative of example content;
program instructions to identify a second parsed segment of text containing a second pointer indicative of example content; and
program instructions to identify a third parsed segment of text between the first and second parsed segments of text, wherein the third parsed segment of text does not contain a pointer indicative of example content.

17. A computer system comprising:
one or more computer processors;
one or more computer-readable storage media; and
program instructions stored on the one or more computer-readable storage media for execution by at least one of the one or more processors, the program instructions comprising:
program instructions to identify one or more sections of a document;
program instructions to parse segments of text within the one or more sections of the document;
program instructions to analyze the parsed segments of text to identify parsed segments of text that are associated with pointers indicative of example content; and
program instructions to generate one or more links between the identified parsed segments of text and one or more topics to which the identified parsed segments of text pertain.

18. The computer system of claim 17, wherein the program instructions stored on the one or more computer-readable storage media further comprise:
program instructions to, responsive to receiving a query, return as a result one or more of the parsed segments of text based, at least in part, on the generated one or more links.

19. The computer system of claim 18, wherein the program instructions to, responsive to receiving a query, return as a result one or more of the parsed segments of text based, at least in part, on the generated one or more links comprise:
program instructions to, responsive to receiving a query for example content, return as a result the identified parsed segments of text.

20. The computer system of claim 18, wherein the program instructions to, responsive to receiving a query, return as a result one or more of the parsed segments of text based, at least in part, on the generated one or more links comprise:
program instructions to, responsive to receiving a query that indicates example content should be excluded from a search result, return as a result one or more of the parsed segments of text, excluding the identified parsed segments of text.
